(19) United States
(12) Patent Application Publication
(10) Pub. No.: US 2024/0068522 A1
(43) Pub. Date: Feb. 29, 2024

(54) SHAFT-GROUNDING BEARING PROTECTION DEVICE AND MOTOR

(71) Applicant: MPT NEWTECH SHANGHAI CO., LTD., Shanghai (CN)

(72) Inventors: Huanfeng LIU, Shanghai (CN); Zheshi LIU, Shanghai (CN)

(21) Appl. No.: 18/505,404

(22) Filed: Nov. 9, 2023

Related U.S. Application Data
(63) Continuation of application No. PCT/CN2022/089435, filed on Apr. 27, 2022.

(30) Foreign Application Priority Data
May 12, 2021 (CN) 202110518610.0

(51) Int. Cl. H02K 11/40; F16C 41/00

(52) U.S. Cl. CPC H02K 11/40; F16C 41/002

(57) ABSTRACT

A shaft-grounding bearing protection device and a motor are provided. The shaft-grounding bearing protection device includes a device body of a ring shape, a side wall of the device body is provided with at least one mounting hole, the mounting hole is a first direction directing toward the center of the device body and radially penetrating through the device body; and a conductive fiber passing through the mounting hole provided on the device body, an extension direction of the conductive fiber is toward the center of the device body. When the conductive fiber passes through the mounting hole, a clamping force in a second direction of the mounting hole is adjusted to realize the crimping of the conductive fiber and the device body, and the second direction is perpendicular to the first direction.

### CROSS-REFERENCE TO RELATED APPLICATION

This application is a continuation of International Patent Application No. PCT/CN2022/089435, filed on Apr. 27, 2022, which claims priority of the Chinese Patent Application No. 202110518610.0, filed on May 12, 2021, both of which are incorporated by references in their entities.

### TECHNICAL FIELD

The present disclosure relates to the field of bearing protection rings, and in particular to a shaft-grounding bearing protection device and a motor.

### BACKGROUND ART

At present, during the use of the motor, bearing protection devices are used to protect the bearings in a motor. However, there are some disadvantages in the prior art.

For example, due to the interference fit installation, some parts (e.g., the inner ring) of the bearing protection device are deformed due to uneven stress during installation, resulting to a situation that the overall conductivity of the final device drops linearly, from the original few ohms to tens of ohms or even hundreds of ohms, which makes the device unable to meet the industrial requirements.

For another example, rear end screw fastening by the existing bearing protection device is not only complicated in process, but also has the defects that the conductive fiber is easy to fall off due to not tightly fastening and not easy to mass production.

Based on this, it is expected to obtain a new shaft-grounding bearing protection device, which can overcome disadvantages in the prior art, reduce the incidence of poor contact, save the conductive fiber materials, simplify production process, and make production, use and installation convenient.

### SUMMARY

In order to overcome disadvantages in the prior art, the disclosure provides a shaft-grounding bearing protection device and a motor. By using a crimping structure, the problems of high resistance, low conductivity, serious fiber breakage, extrusion deformation and inability to improve production capacity are solved, and achieves low resistance, high conductivity, low fiber breakage and easy to mass production.

To achieve the objectives above, the disclosure is realized through the following aspects:

First, the disclosure provides a shaft-grounding bearing protection device is provided, including:
a device body of a ring shape, with at least one mounting hole on a side wall of the device body, the mounting hole is the first direction, and the first direction directs toward the center of the device body and extends along the radial direction of the device body.

The conductive fiber is arranged on the device body through the mounting hole, and the extension direction of the conductive fiber is toward the center of the device body.

When the conductive fiber passes through the mounting hole, the clamping force in the second direction of the mounting hole is adjusted to realize the crimping of the conductive fiber and the device body, and the second direction is perpendicular to the first direction.

In the technical solution of the disclosure, the crimping is essentially to fasten the conductive fiber to the device body by using the deformation force of the metal part, without the need to use additional means (such as the bonding method commonly used in the prior art). This method can make the shaft-grounding bearing protection device in this case applicable to a molding process, greatly simplify the process flow, greatly improve the process efficiency, and because there is no need for additional bonding, which can avoid the poor contact caused by the bonding process, greatly reduce the incidence of poor contact.

In some embodiments, the device body includes a first ring-shaped half body and a second ring-shaped half body provided in pairs. The first ring-shaped half body and/or the second ring-shaped half body are provided with grooves, so as to form a mounting hole inside the device body when the first ring-shaped half body is connected to the second ring-shaped half body.

In some embodiments, the clamping force in the second direction of the mounting hole comprises one of the following modes: manual clamping, mechanical clamping, and hydraulic clamping.

In some embodiments, crimping slots are formed at the acting site of the crimping force. According to specific conditions of each embodiment, the crimping slot may be used for second fixation of the conductive fiber, so as to improve the conductivity between the conductive fiber and the ring shape structural part.

In some embodiments, the device body is made of at least one of the following materials: aluminum alloy, brass alloy, and stainless-steel alloy.

Considering that stainless steel is easy to wear, in order to improve durability, aluminum alloy or brass alloy is preferred.

Certainly, it is conceivable that in some other embodiments, the device body may also be made of other conductive materials with high conductivity and high durability.

In some embodiments, the conductive fiber is made of one of carbon fiber, metal fiber and graphene fiber.

Certainly, it is conceivable that in some other embodiments, the conductive fiber can also be other materials and is not limited to the carbon fiber, the metal fiber and the graphene fiber. However, considering the electrical conductivity and the flexibility of the material, the carbon fiber or graphene fiber is preferred.

In some embodiments, the conductive fiber is composed of 2-100 bundles of conductive fiber filament groups, and each bundle of conductive fiber filament group includes 300-120000 conductive fiber filaments.

In some embodiments, when the conductive fibers are at least two bundles, the conductive fibers are centrally symmetric along a circumferential direction of the device body.

It needs to be noted that the conductive fibers may also be asymmetrically arranged along the circumferential direction of the device body.

In some embodiments, the conductive fibers are arranged in two groups up and down along the axial direction of the device body.

In some more preferred embodiments, the conductive fiber is arranged in two groups up and down along the axial direction of the device body, each group of conductive fiber is centrally symmetric along the circumferential direction of the device body. Preferably, the shaft-grounding bearing protection device includes a current guiding end. The current guiding end is arranged at the end away from the center of the device, of the mounting hole, and the current guiding end is bonded to the conductive fiber or tied directly to the conductive fiber.

In the second aspect, the disclosure also provides a motor, which comprises the shaft-grounding bearing protection device.

Compared with the prior art, the disclosure has the following advantages and beneficial effects:

1. The disclosure solves the problems of high resistance, low conduction, serious fiber breakage, extrusion deformation and inability to improve production capacity by using the structure of crimping mode. The resistance can be reduced to less than 10 ohms, the fiber breakage rate is less than 3%, and the disclosure can be formed in one time to realize rapid production.

2. Compared with the prior art, the problem of bearing electric corrosion is solved due to the application of the shaft-grounding bearing protection device to the motor, and the service life of the motor is extended.

3. Compared with the prior art, when the disclosure is used, the resistance can be reduced to less than 3 ohms, the bearing electric corrosion can be completely eliminated, and the bypass conduction rate can reach 100%.

### BRIEF DESCRIPTION OF THE DRAWINGS

Other characteristic purposes and advantages of the disclosure will become more apparent by reading the detailed description of non-restrictive embodiments with reference to the attached drawings below.

FIG. 1 is a structural schematic diagram of a shaft-grounding bearing protection device according to Embodiment 1;

FIG. 2 illustratively shows a conductive fiber of the shaft-grounding bearing protection device according to Embodiment 1 in a mounting hole;

FIG. 3 illustratively shows a sectional view of a shaft-grounding bearing protection device according to Embodiment 1;

FIG. 4 is a structural schematic diagram of a shaft-grounding bearing protection device according to Embodiment 2;

FIG. 5 illustratively shows a conductive fiber of the shaft-grounding bearing protection device according to Embodiment 2 in a mounting hole;

FIG. 6 illustratively shows a sectional view of a shaft-grounding bearing protection device according to Embodiment 2;

FIG. 7 is a schematic diagram of an overall structure of a shaft-grounding bearing protection device according to Embodiment 2.

In the drawings:
1, device body; 2, conductive fiber; 3, mounting hole; 4, crimping slot; 5, plugging process hole; 11, first ring-shaped half body, 12, second ring-shaped half body; 121, dust-proof ring.

### DETAILED DESCRIPTION OF THE EMBODIMENTS

The present disclosure is described in detail in combination with specific embodiments. The following embodiments will assist those skilled in the art to further understand the disclosure, but do not limit the disclosure in any way. It should be noted that for ordinary technicians in the field, several changes and improvements can be made without deviating from the concept of the disclosure. These belong to the protection scope of the disclosure.

### Embodiment 1

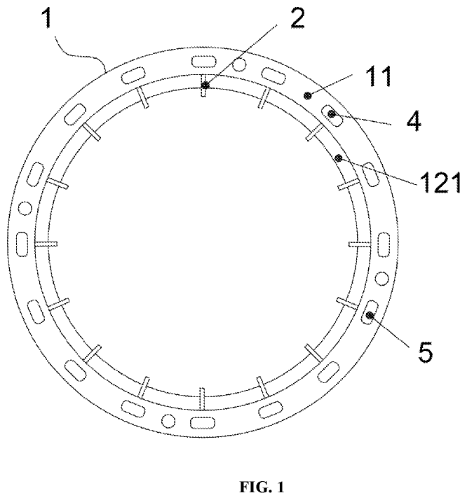

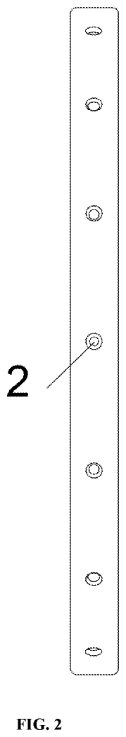

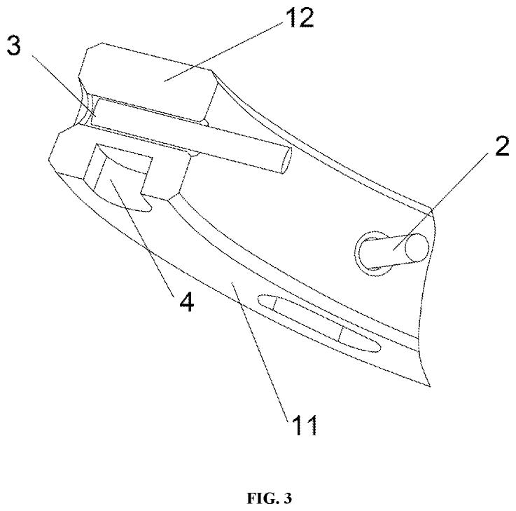

FIG. 1 is a structural schematic diagram of a shaft-grounding bearing protection device according to Embodiment 1. FIG. 2 illustratively shows a conductive fiber of the shaft-grounding bearing protection device according to Embodiment 1 in a mounting hole. FIG. 3 illustratively shows a sectional view of a shaft-grounding bearing protection device according to Embodiment 1.

As shown in FIG. 1, and refer to FIG. 2 and FIG. 3 when necessary, in this embodiment, the shaft-grounding bearing protection device includes a device body 1 of a ring shape, and a conductive fiber 2.

Wherein, there is at least one mounting hole 3 on a side wall of the device body 1 (as shown in FIG. 1, the number of mounting holes in this case is 16, equally spaced along the circumference; of course, in some other embodiments, other numbers can be set according to the specific circumstances of each embodiments, such as two, four or eight). The direction of mounting hole 3 is the first direction. The first direction is toward the center of device body 1 and penetrates radially along device body 1.

The conductive fiber 2 passes through the mounting hole 3 on the device body 1, and the direction of the conductive fiber 2 directs toward the center of the device body 1.

When the conductive fiber 2 passes through the mounting hole 3, crimping of the conductive fiber 2 and the device body 1 is achieved by adjusting a clamping force in a second direction of the mounting hole 3, and the second direction is perpendicular to the first direction.

With further reference to FIG. 3, it can be seen that the device body 1 includes a first ring-shaped half body 11 and a second ring-shaped half body 12 provided in pairs. The second ring-shaped half body (12) is provided with a dust-proof ring (121), and the first ring-shaped half body 11 and/or the second ring-shaped half body 12 are provided with grooves, so as to form a mounting hole inside the device body 1 when the first ring-shaped half body 11 is connected to the second ring-shaped half body 12.

Adjusting clamping force in the second direction of the mounting hole 3 comprises one of the following modes: manual clamping, mechanical clamping, and hydraulic clamping.

In this embodiment, the mechanical clamping is preferred, and crimping slots 4 are formed at points of action of the clamping force. According to specific conditions of various embodiments, the crimping slots 4 may be plugged with process hole 5.

The device body 1 is made of aluminum alloy. Certainly, in some other embodiments, the device body 1 may also be made of other conductive materials such as brass and stainless steel. While the conductive fiber 2 is made of the carbon fiber. The conductive fiber 2 is composed of 2-100 bundles of conductive fibers, and each bundles of conductive fiber includes 300-120000 conductive fiber filaments.

Certainly, in some other embodiments, other conductive materials may also be selected according to specific conditions of various embodiments, for example, the metal fiber or graphene fiber, or a mixed fiber of any combination of the carbon fiber, the metal fiber, and the graphene fiber, a combination mode of which is that two or all of the carbon fiber, metal fiber and graphene fiber are mixed.

### Embodiment 2

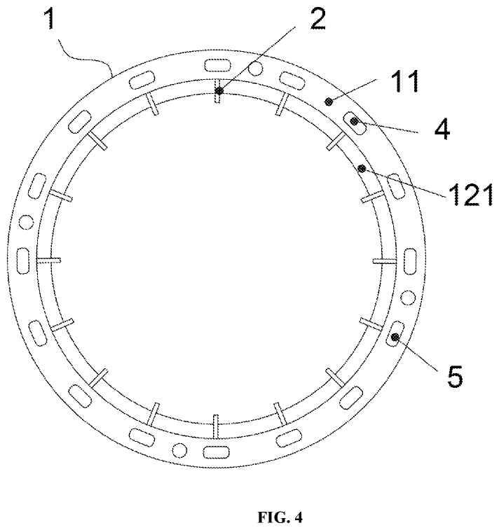

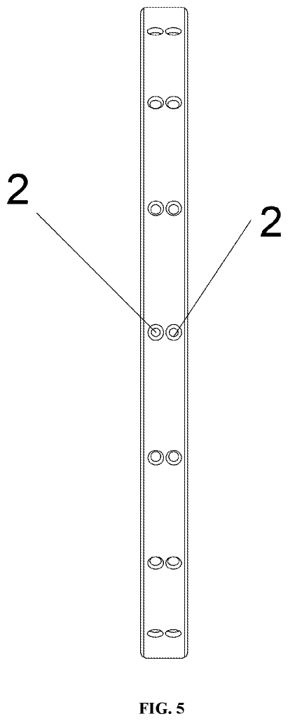

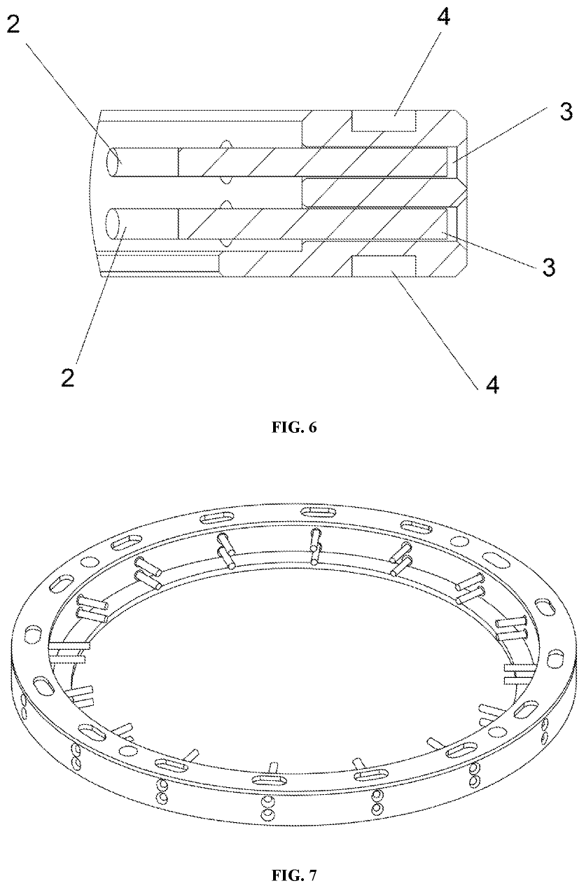

FIG. 4 is a structural schematic diagram of a shaft-grounding bearing protection device according to Embodiment 2. FIG. 5 illustratively shows a conductive fiber of the shaft-grounding bearing protection device according to Embodiment 2 in a mounting hole. FIG. 6 illustratively shows a sectional view of a shaft-grounding bearing protection device according to Embodiment 2. FIG. 7 is a schematic diagram of an overall structure of a shaft-grounding bearing protection device according to Embodiment 2.

As can be seen from FIG. 4 through FIG. 7, a structure of the shaft-grounding bearing protection device in this embodiment is the same as that in Embodiment 1, and the difference is that two groups of conductive fibers 2 are provided from top to bottom in an axial direction of the device body 1, and each group of conductive fibers is centrally symmetric along a circumferential direction of the device body. The structure of the conductive fiber can be clearly seen with reference to FIG. 5.

In addition, according to FIG. 6 and FIG. 7, when clamped, a clamping force can be respectively applied inwards on both sides of the first ring-shaped half body 11 and the second ring-shaped half body 12 along the axial direction of the device body, so as to crimp the conductive fiber 2 into the device body. At this time, the conductive fiber 2 is of a fan shape in the mounting hole 3 due to the action of the clamping force, so as to be better fixed into the mounting hole 3. The clamping force can be adjusted by the amount of mechanical feed, and parameters can be stably controlled by a mechanical control device, for better batch processing.

The conductive fiber 2 can be assembled into the mounting hole 3 by the following steps: hooking the conductive fiber into the hole, adjusting the conductive fiber to a required length, cutting the conductive fiber, and crimping and fixing the conductive fiber with the crimping slots.

In some preferred embodiments, a reinforced fixation may be performed by dispensing glue inside the crimp hole.

### Embodiment 3

An overall structure of the shaft-grounding bearing protection device in this embodiment is the same as that in Embodiment 1, and the difference is that the shaft-grounding bearing protection device includes a current guiding end. The current guiding end is arranged at the end away from the center of the device 1, of the mounting hole 3, and the current guiding end is bonded to the conductive fiber 2 or tied directly to the conductive fiber, to increase the conductivity of the shaft-grounding bearing protection device.

Specific embodiments of the present disclosure are described above. It should be understood that the present disclosure is not limited to above particular embodiment. Those skilled in the art can make various changes and modification in the scope of claims without affecting the essential content of the present disclosure. The embodiments of the present disclosure and the features of the embodiments may be combined with each other without any conflict.

What is claimed is:

1. A shaft-grounding bearing protection device, comprising:
a device body of a ring shape, wherein a side wall of the device body is provided with at least one mounting hole, an opening direction of the mounting hole is a first direction, and the first direction directs toward a center of the device body and radially penetrates through the device body; and
a conductive fiber passing through the mounting hole provided on the device body, and an extension direction of the conductive fiber is toward the center of the device body,
wherein when the conductive fiber passes through the mounting hole, a clamping force in a second direction of the mounting hole is adjusted to realize crimping of the conductive fiber and the device body, and the second direction is perpendicular to the first direction; and
wherein during clamping, the clamping force is applied inwards on both sides of the device body in an axial direction of the device body to crimp the conductive fiber into the device body; the conductive fiber is of a fan shape in the mounting hole, and crimping slots are formed at a points of action of the clamping force on the device body.

2. The shaft-grounding bearing protection device according to claim 1, wherein the device body comprises a first ring-shaped half body and a second ring-shaped half body provided in pairs, the first ring-shaped half body and/or the second ring-shaped half body are provided with grooves, so as to form the mounting hole inside the device body when the first ring-shaped half body is connected to the second ring-shaped half body.

3. The shaft-grounding bearing protection device according to claim 1, wherein the clamping force in the second direction of the mounting hole is adjusted by means of one of manual clamping, mechanical clamping, and hydraulic clamping.

4. The shaft-grounding bearing protection device according to claim 1, wherein the device body is made of at least one of the following materials: aluminum alloy, brass alloy, and stainless-steel alloy.

5. The shaft-grounding bearing protection device according to claim 1, wherein the conductive fiber is made of one of carbon fiber, metal fiber and graphene fiber.

6. The shaft-grounding bearing protection device according to claim 5, wherein the conductive fiber is composed of 2-16 bundles of conductive fiber filament groups, and each bundle of conductive fiber filament group comprises 300-1200 conductive fiber filaments.

7. The shaft-grounding bearing protection device according to claim 1, wherein the conductive fiber is arranged in two groups up and down along the axial direction of the device body.

8. The shaft-grounding bearing protection device according to claim 1, further comprising a current guiding end arranged at an end, away from a center of the device, of the mounting hole, wherein the current guiding end is bonded to the conductive fiber or tied directly to the conductive fiber.

9. A motor, comprising the shaft-grounding bearing protection device according to claim 1.

10. The motor according to claim 9, wherein the shaft-grounding bearing protection device is provided on the motor in an interference fit.

11. The motor according to claim 9, wherein the device body comprises a first ring-shaped half body and a second ring-shaped half body provided in pairs, the first ring-shaped half body and/or the second ring-shaped half body are provided with grooves, so as to form the mounting hole inside the device body when the first ring-shaped half body is connected to the second ring-shaped half body.

12. The motor according to claim 9, wherein the clamping force in the second direction of the mounting hole is adjusted by means of one of manual clamping, mechanical clamping, and hydraulic clamping.

13. The motor according to claim 9, wherein the device body is made of at least one of the following materials: aluminum alloy, brass alloy, and stainless-steel alloy.

14. The motor according to claim 9, wherein the conductive fiber is made of one of carbon fiber, metal fiber and graphene fiber.

15. The motor according to claim 14, wherein the conductive fiber is composed of 2-16 bundles of conductive fiber filament groups, and each bundle of conductive fiber filament group comprises 300-1200 conductive fiber filaments.

16. The motor according to claim 9, wherein the conductive fiber is arranged in two groups up and down along the axial direction of the device body.

17. The motor according to claim 9, further comprising a current guiding end arranged at an end, away from a center of the device, of the mounting hole, wherein the current guiding end is bonded to the conductive fiber or tied directly to the conductive fiber.
